(19) United States
(12) Patent Application Publication
(10) Pub. No.: US 2011/0302215 A1
(43) Pub. Date: Dec. 8, 2011

(54) ASSEMBLY, AND ASSOCIATED METHOD, FOR CONTROLLING DISPOSITION OF ENTERPRISE DATA AT A WIRELESS DEVICE

(75) Inventors: Jeffrey J. Holleran, Viera, FL (US); Robert Bowerman, Waterloo (CA); Andrew Douglas Bocking, Waterloo (CA); Peter Lawrence Mitchelmore, Elk Grove, CA (US); Santiago Carbonell Duque, Waterloo (CA); Carl L. Cherry, Waterloo (CA); Jonathan Raymond Cardy, Waterloo (CA); Joseph Patrick Thomas Goguen, Redwood City, CA (US); Ronald Scotte Zinn, Waterloo (CA); Catherine Michelle Coode, Waterloo (CA)

(73) Assignee: RESEARCH IN MOTION LIMITED, Waterloo (CA)

(21) Appl. No.: 12/794,030

(22) Filed: Jun. 4, 2010

(51) Int. Cl. G06F 17/30

(52) U.S. Cl. 707/802; 707/E17.005

(57) ABSTRACT

An apparatus, and an associated method, facilitates enterprise control of enterprise data at a personal-liable wireless device. A network-generated command, generated by a network command generator is sent to the wireless device. The command is detected at the wireless device, and the contents of the detected command are ascertained. The affected data is accessed, and disposition is made of the affected, enterprise data.

The present disclosure relates generally to a manner by which to control disposition of enterprise data stored at a personal-liable, wireless device. More particularly, the present disclosure relates to an apparatus, and an associated method, by which to cause deletion, or other disposition, of the enterprise data by sending a command, generated at the enterprise network, to the wireless device. When detected at the wireless device, the wireless device operates upon the enterprise data in conformity with the command.

An enterprise maintains control over the enterprise data at the personal-liable wireless device while permitting a user to utilize a personal-liable device to connect with an enterprise network rather than an enterprise-provided wireless device.

### BACKGROUND

Recent decades have witnessed significant advancements and changes in wireless communication technologies, providing new communication capabilities for many wireless communications systems. Wireless communication devices, configured to operate in such communication systems and of constructions that take advantage of the new communication capabilities are used by many. And, for many, use of wireless devices to communicate by way of wireless communication systems form a primary communication mechanism for both personal and business communication activities. For instance, in some areas, the penetration rate of users of cellular communication devices exceeds that of users of conventional, wire line devices.

While early-generation, cellular devices and systems provided primarily for voice communication, new-generation systems increasingly provide for data-intensive communications, which take advantage of advanced communication technologies, to carry out data-intensive communication services and applications. Text messaging services and email services are amongst the data services that are widely utilized by way of wireless devices.

Business and other enterprises regularly make use of wireless devices and wireless communication systems to carry out enterprise communication services. Through such use, enterprise personnel are able to communicate, to send and to receive data, and to perform communication services by way of such wireless devices without the need physically to be located at an enterprise facility or location. At least one system, utilizing an enterprise-maintained communication server, referred to herein at times as an enterprise server, provides for secured communication of data with wireless devices, thereby to ensure secured communication of the data. When used pursuant to a messaging service, the enterprise server is placed in communication connectivity with an enterprise message server, such as a Microsoft Exchange™ server. The Exchange or other server notifies the enterprise data is sometimes proprietary data. Care is exercised to prevent the unauthorized access to the data communicated to a wireless device, which is sometimes stored at the wireless device subsequent to its delivery. Additionally, enterprise applications and other information might be stored, or otherwise maintained, at the wireless device. Such efforts represent a significant challenge to enterprise personnel in charged with maintaining the security of the data stored at the wireless devices, which regularly are not physically located at, or under the physical control of the enterprise.

When the wireless devices are provided by the enterprise, that is, the wireless devices are enterprise-liable, the enterprise is generally able to maintain an acceptable level of control over the wireless device. For instance, in the event of loss or theft of the wireless device, at least one, existing enterprise server is configured to cause the deletion of data at the wireless device, or otherwise prevent unauthorized access thereto.

Increasingly, enterprise personnel have their own wireless devices, referred to as personal-liable device, that are of capabilities that permit their use to communicate pursuant to data-intensive communication services. And, concomitant with this increase, enterprise personnel increasingly request that their own wireless devices be used pursuant to enterprise communication services. Enterprises are generally resistant to permitting personal-liable devices to be connected to an enterprise network. Enterprise network operators conventionally have lesser control over personal-liable devices. A weakly-authenticated personal-liable device might provide, e.g., a malicious intruder entry to the enterprise network and access to the information maintained thereat.

Existing enterprise, security control mechanisms are generally configured for use in conjunction with enterprise-liable wireless devices and not personal-liable wireless devices. Due to the general lack of existing mechanisms by which to effectuate control over enterprise data at a wireless device that is not an enterprise-liable wireless device, enterprise personnel are generally reluctant to provide access to the personal-liable wireless device.

It is in light of this background information related to personal-liable wireless devices that the significant improvements of the present disclosure have evolved.

### BRIEF DESCRIPTION OF THE DRAWINGS

FIG. 1 illustrates a functional block diagram of a communication system in which an embodiment of the present disclosure is embodied.

FIG. 2 illustrates a message sequence diagram representative of signaling generated during operation of an embodiment of the present disclosure.

FIG. 3 illustrates a method flow diagram representative of the method of operation of an embodiment of the present disclosure.

### DETAILED DESCRIPTION

The present disclosure, accordingly, advantageously provides an apparatus, and an associated methodology, by which to control disposition of enterprise data stored at a personal-liable, wireless device.

Through operation of an embodiment of the present disclosure, a manner is provided by which to cause deletion, or other, disposition of the enterprise data at the personal-liable device. A command, generated at the enterprise network, is generated and sent to the personal-liable wireless device. The wireless device operates upon the enterprise data in conformity with the command.

Other data stored at the wireless device, i.e., non-enterprise data, such as data related to non-enterprise communication services, is unaffected by the command and the resultant disposition of the enterprise data. Secured control of the enterprise data is provided while also permitting non-enterprise data and services to be continued to be performed irrespective of the disposition of the enterprise data.

In another aspect of the present disclosure, the selection to make disposition of data is made by enterprise personnel and provided to an enterprise-positioned selection detector. The selection initiated by the enterprise personnel identifies, e.g., which wireless device is to be affected, when the disposition is to be made, and upon what data the disposition is to be made.

In another aspect of the present disclosure, responsive to detection of the selection to initiate disposition of data at a wireless device, a command is generated at a network entity, such as at an enterprise server. The command forms an instruction to one or more wireless devices to make disposition of enterprise data at a personal-liable wireless device. The generated command identifies the affected wireless device, the type of disposition of the enterprise data, and the affected data. In one implementation, the command comprises a command to wipe, delete, or otherwise disable all enterprise data at the affected wireless device. If the command is always to delete all of the enterprise data at the affected wireless device, identification of which portions of the enterprise data to delete need not be included in the command as the command is interpreted to wipe all enterprise at the affected wireless device. In one implementation, absence of the identification of the enterprise data comprises an instruction, known to the wireless device to make a specific disposition of certain enterprise data at the wireless device, thereby also to reduce the bandwidth required of the command.

In another aspect of the present disclosure, the enterprise personnel make selection to disable, delete, or wipe selected portions of the enterprise data at the wireless device. The selected portion of the enterprise data pertains, for instance, to a specific service that is to be disabled and no longer permitted at the wireless device. Because disposition is made of only the selected enterprise data, and not any personal-liable data, communication services that are not enterprise-related are not affected by the command. Disposition of the enterprise data is controlled while not affecting the personal-liable data. Thereby, for instance, if a user, subsequent to use of the personal-liable device with the enterprise later elects no longer to utilize the personal-liable device in conjunction with the enterprise, the personal-liable wireless device remains operable for non-enterprise services.

In another aspect of the present disclosure, a personal-liable device is positioned in communication connectivity with a radio access network. When so-positioned, the personal-liable wireless device is able to receive a disposition command generated by the enterprise regarding disposition of the enterprise data at the wireless device. When a command is issued by an enterprise, the command is routed to a radio access network and sent, by way of a radio air interface, to the wireless device. A receive part of the wireless device receives the command, and its reception is detected, such as at a command detector. The detection of the command includes, for instance, analysis of the contents of the command to ascertain to what the command pertains. That is to say, the command detector detects reception of the command and ascertains its contents.

In another aspect of the present disclosure, the personal-liable, wireless device acts in conformity with the command to make disposition of enterprise data stored at the wireless device. A controller receives indications of the detected command, and the controller operates to access the affected data and to operate upon the affected data in conformity with the disposition identified in the command. Disposition is made of the enterprise data without affecting personal data, such as personal data pertaining to a personal-liable service.

In these and other aspects, therefore, an apparatus, and an associated method, is provided for a wireless device. A data disposition command detector is configured to detect reception at the wireless device of a host-service-data disposition command. And a data controller is configured to make disposition of the host-service data responsive to the host-service-data disposition command. The disposition of the host-service data preserves non-host-service-associated services provisioned at the wireless device.

In these and other aspects, further apparatus, and an associated methodology, is provided for a network to facilitate wireless-device control. A selection detector is configured to detect host-service selection to make disposition of wireless-device, host-service data. A command generator is adapted to receive indication of selection detected by the selection detector. The command generator is configured to generate a host-service-data disposition command that commands disposition of the wireless-device, host-service data in conformity with the selection while preserving non-host-service-associated services.

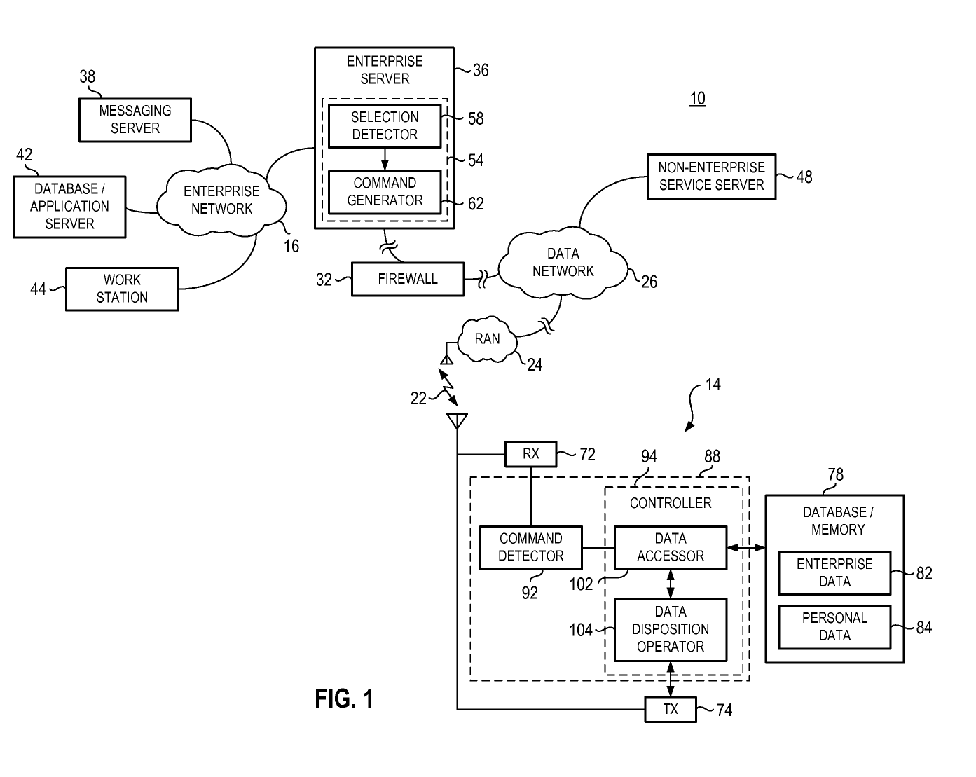

Turning first, therefore, to FIG. 1, a communication system, shown generally at 10, provides for communications with a wireless device 14. In the exemplary implementation, the communication system forms a multiple-access radio communication system permitting communications with large numbers of wireless devices. While only a single wireless device 14 is shown in FIG. 1, in a typical implementation, the communication system includes a plurality of mobile stations 14.

The wireless device 14 here comprises a personal-liable device that is operable as a communication endpoint in communication connectivity with communication entities of an enterprise network 16. Communication connectivity is provided with the personal-liable wireless device by way of a radio air interface 22, a radio access network (RAN) 24, and a data network 26. In the exemplary implementation, the communication system provides for data communication services, such as messaging or other email services.

The enterprise network 16 is connected to the data network 26, such as the internet, positioned behind a firewall 32. The entities of, or connected to, the enterprise network include an enterprise server 36, a messaging server 38, a database and application server 42, and a computer workstation 44. Additional, or other, entities can be analogously represented and form part of, or be connected to, the enterprise network. The messaging server 38 is representative of a server that is used pursuant to effectuation of a messaging service, such as an email service. And, the database and application server 42 is representative of a database server and also a server operable pursuant to a selected communication service or other application. And, the work station 44 is representative of a work station used for any exemplary purpose, here, e.g., for enterprise personnel to perform network maintenance and control of network operations, including enterprise aspects of the personal-liable wireless device 14. The enterprise server operates, amongst other things, in the routing of communication messages to and from a wireless device 14 communicated pursuant to a messaging or other email service. And, other control aspects, including control provided pursuant to operation of an embodiment of the present disclosure, are also carried out by way of the enterprise server 36. More generally, the server 36 is representative of a server utilized by any various host service providers that provide a host service in which host data is storable or otherwise maintained at a personal-liable wireless device. While exemplary operation is described with respect to disposition of enterprise data at a personal-liable, wireless device by command of a network, this operation is more generally representative of disposition of data at a generic wireless device of any of various host services by a host service entity.

The communication system 10 further includes a non-enterprise service server 48 that operates pursuant to a non-enterprise activity or service, such as a non-enterprise email service. The server 48 is also representative of any of various other servers or other entities that pertain to non-enterprise activities.

The enterprise server includes an apparatus 54 of an embodiment of the present disclosure. The entities of the apparatus 54 are functionally represented, implementable in any desired manner, including algorithms executable by a processor, hardware entities, and combinations thereof. While the apparatus 54, in the exemplary implementation, is embodied at the enterprise server, in other implementations, the functions provided by the entities of the apparatus are performed at other locations, or distributed amongst other entities.

The apparatus 54, comprising network apparatus, includes a selection detector 58 and a command generator 62. The selection detector operates to detect selection of initiation of disposition of enterprise data stored, or otherwise resident or maintained at, the personal-liable wireless device 14. Selection is initiated, for instance, by an enterprise operator working at a computer workstation, such as the workstation 44. An indication of a detected selection is provided to the command generator 62. And, the command generator generates a command responsive to the detected selection. The command forms a command to instruct the disposition of enterprise data at the wireless device. The command includes, or is encapsulated in another message that permits communication of the command to, the wireless device 14. The command includes, or is indicative of, instructions to make disposition of enterprise data at the wireless device. The command also includes, for instance, an identification of the enterprise data that is to be affected.

Howsoever formatted, the command, once generated, is caused to be routed through the data network 26, the radio access network 24, and by way of the radio air interface 22, to the personal-liable wireless device. The wireless device 14 includes transceiver circuitry, here represented by a receive part 72 and a transmit part 74 that operate to receive and to transmit, respectively, communication data pursuant to a communication service. The personal-liable wireless device also includes a database maintained at a memory element 78. Both enterprise data 82 and non-enterprise data, here indicated as personal data 84, is stored at the memory 78. The enterprise data comprises data associated with the enterprise, and the personal data is associated with non-enterprise applications, services, and associated information. Enterprise data, in the exemplary implementation, is tagged with a tag, or other identification, to indicate the data to be enterprise data. And, non-enterprise data is analogously tagged to indicate it to be non-enterprise data.

The personal-liable wireless device further includes an apparatus 88 of an embodiment of the present disclosure. The apparatus 88, represented in FIG. 1, is formed of functional entities, implementable in any desired manner including, for instance, software algorithms executable by processing circuitry, hardware entities, and combinations thereof.

In the exemplary implementation, the apparatus 88 includes a command detector 92 and a controller 94. The command detector operates to detect reception at the personal-liable wireless device of the command generated at the network of the enterprise to make disposition of enterprise data maintained at the wireless device. When a command is detected, the contents of the command are ascertained, and indications thereof are provided to the controller 94. The controller, amongst other things, includes the functionality of a data accessor 102 and a data disposition operator 104. The data accessor functionality of the controller functions to access the memory 78 and the enterprise data stored thereat whose disposition is commanded by the detected command, detected by the command detector. The enterprise data is, in the exemplary implementation, tagged with an indication at least to indicate that the data comprises enterprise data. And, also in the exemplary implementation, the personal data is tagged with an indication to identify the personal data as being non-enterprise data.

Once the data has been accessed, the data disposition operator functions to make disposition of the enterprise data identified in the command. In one implementation, the command forms a command to delete, wipe, or otherwise disable the data stored at the memory 78 that is tagged to indicate the data to form enterprise data. In another implementation, the command detected by the detector indicates a portion of the enterprise data. In this implementation, the data accessor accesses the identified portion of the enterprise data, and the data disposition operator functions to make disposition of the selected portion of the enterprise data. And, in another implementation, the disposition of the data is a disposition other than deletion, wiping, or disabling of the enterprise data. For instance, in another implementation, the disposition command comprises a command to block a copy and paste operation from enterprise to non-enterprise services and applications, to block cross-service forwarding, and to toggle on and off services, and data associated with such services.

Thereby, enterprise concerns associated with maintenance of the security of enterprise data at a personal-liable wireless device are alleviated as the command that is generated provides for disposition of the enterprise data without affecting the personal-liable data, i.e., data that is not associated with the enterprise.

More generally, a new method or feature is provided to a host service provider by which to control disposition of host-service data stored or otherwise maintained at a personal-liable, wireless device. Election is made to make disposition of host-service data stored or maintained at the wireless device. A command is generated, which indicates the disposition election. And, the command is sent to the personal-liable wireless device. Once received at the personal-liable wireless device, the host-service is operated upon in conformity with the command. Disposition is made of a portion of the data, the host-service data, responsive to the command while not affecting other data, non-host-associated data.

In one implementation, three sets of personal information manager (PIM) information data are utilized at the wireless device, sets of contact data, email data, and calendar data. Each set includes data tagged as enterprise information data and non-enterprise data. For instance, email messages, and their attachments, are tagged to be either enterprise email data or non-enterprise email data. Contact data is tagged to be either enterprise contact data or non-enterprise contact data. And, calendar data is tagged to be either enterprise calendar data or non-enterprise calendar data. Other sets of data are similarly configured. In essence, the data communicated to and from the personal-liable wireless device comprise separate channels of data, i.e., enterprise data and non-enterprise data. Such data is tagged to indicate the data to be enterprise or non-enterprise data. And, when a command to make disposition of the enterprise data is generated and provided to the wireless device, the enterprise data is affected while not affecting the non-enterprise data. For instance, in this exemplary scenario, the command sent to the wireless device comprises a command to wipe any of the enterprise data of the contact, email, and calendar sets of data. That is to say, e.g., a command to delete the enterprise contact data causes deletion of the enterprise contact data without affecting the non-enterprise contact data (or any of the data of the other data sets). And, e.g., a command to delete the enterprise contact and email data, causes deletion of the enterprise contact and calendar data without affecting the non-enterprise contact or email data (or any of the data of the remaining data set). Also, e.g., a command to delete the enterprise contact, email, and calendar data causes deletion of such data without affecting the non-enterprise data. And, in one implementation, the command generated by the command generator affects a plurality of personal-liable wireless devices. The same dispositions are made to the enterprise data of each of the plurality.

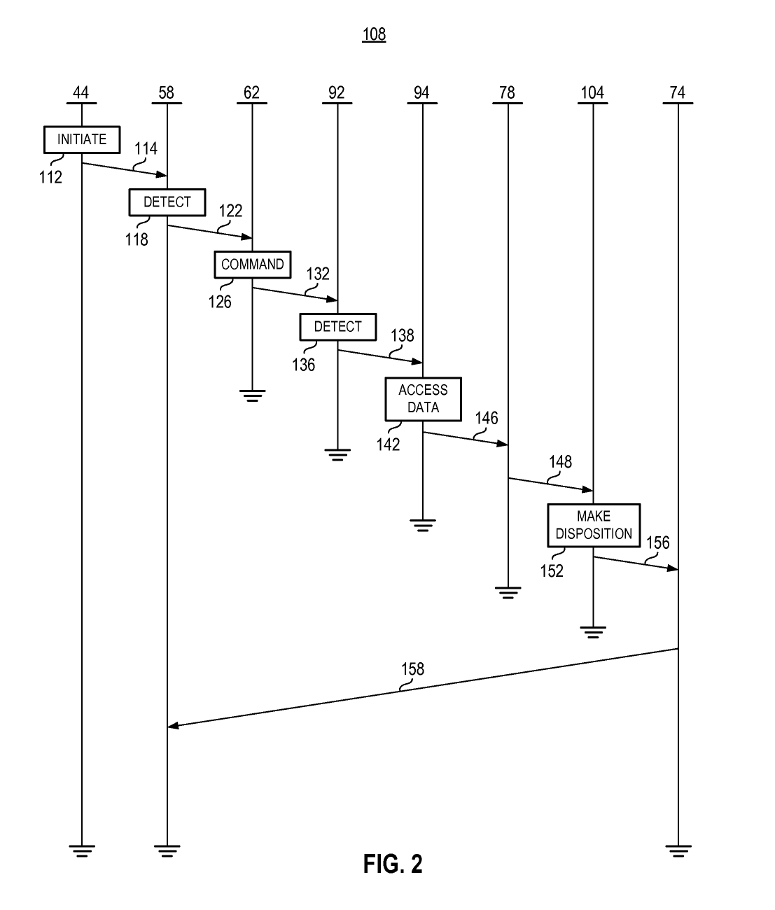

Turning next to FIG. 2, a diagram, shown generally at 108, is representative of exemplary operation of the communication system 10, shown in FIG. 1. Operation is represented in which a command is generated to command the disposition of enterprise data at the personal-liable wireless device.

Here, selection to initiate generation of a command is made at a work station 44, indicated by the initiate block 112. An indication of the selection to initiate the generation of the command is provided, here indicated by the segment 114, to the enterprise server 58. Detection is made, indicated by the detect block 118, of the selection. An indication of the detected selection is provided, here indicated by the segment 122, to the command generator 62. And, in response, a command is generated, indicated by the block 126.

Once the command is generated, the command is caused to be routed, here indicated by the segment 132, through the data and radio access networks 26 and 24, over the radio air interface 22 (all shown in FIG. 1) and delivered to the personal-liable wireless device 14. Reception at the wireless device of the command is detected, indicated by the block 136, by the command detector 92. An indication of the detected command is provided, here indicated by the segment 138, to the controller 94. The controller accesses, indicated by the block 142, the affected enterprise data maintained at the memory 78. And, subsequent to its access, the accessed data, indicated by the segment 148, is deleted, wiped, disabled, or otherwise disposition is made of the affected data, indicated by the block 152, in conformity with the command. Here, once the disposition of the data is made, an indication of the disposition is provided, indicated by the segment 156, to the transmit part 74, and the transmit part provides an indication of the disposition of the data, indicated by the segment 158, to the enterprise server.

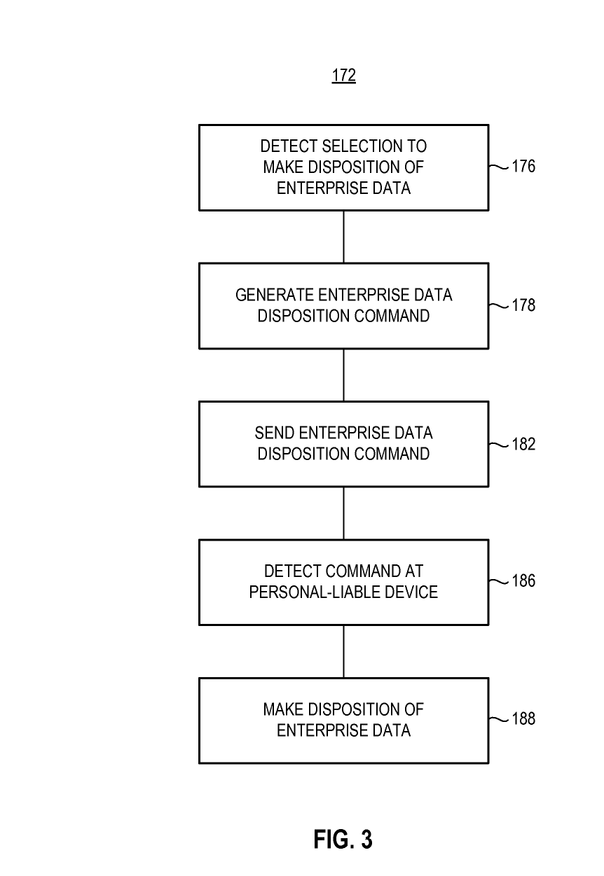

FIG. 3 illustrates a message sequence diagram, shown generally at 172, representative of the method of operation of an embodiment of the present disclosure. The method facilitates enterprise control of a personal-liable wireless device. First, and as indicated by the block 176, detection is made of enterprise selection to make disposition of enterprise data maintained at a personal-liable, wireless device. Then, and as indicated by the block 178, an enterprise-data disposition command is generated. The command is generated responsive to detection of the enterprise selection. The enterprise-data disposition command commands disposition of the enterprise data at the wireless device in conformity with the selection while preserving the wireless-device, non-enterprise-associated services.

The command once generated, is sent, indicated by the block 182, to the personal-liable wireless device. Once delivered to the wireless device, reception of the enterprise-data disposition command is detected, indicated by the block 186. And, as indicated by the block 188, disposition of the enterprise data is made at the personal-liable wireless device. The disposition is made of the enterprise data while preserving non-enterprise-associated services provisioned at the personal-liable wireless device.

Thereby, a manner is provided by which an enterprise is able to control the enterprise data maintained at the personal-liable wireless device while not affecting non-enterprise-related data.

Presently preferred embodiments of the disclosure and many of its improvements and advantages have been described with a degree of particularity. The description is of preferred examples of implementing the disclosure and the description of preferred examples is not necessarily intended to limit the scope of the disclosure. The scope of the disclosure is defined by the following claims.

1. An apparatus for a wireless device, said apparatus comprising:
a data disposition command detector configured to detect reception at the wireless device of a host-service-data disposition command; and
a data controller configured to make disposition of host-service-data responsive to the a host-service-data disposition command detected by said data disposition command detector, the disposition of the host-service data preserving non-host-service-associated services provisioned at the wireless device.

2. The apparatus of claim 1 wherein said data disposition command detector is configured to detect reception at the wireless device of the host-service-data-disposition command that commands deletion of host-service data at the wireless device.

3. The apparatus of claim 2 wherein said host-service data controller is configured to cause deletion of the host-service data at the wireless device.

4. The apparatus of claim 2 wherein the host-service-data disposition command that commands the deletion of the host-service data further comprises an indication of which portion of the host-service data that is commanded to be deleted.

5. The apparatus of claim 2 wherein said controller is configured to cause deletion of host-service data associated with a selected wireless-device-installed service.

6. The apparatus of claim 5 wherein the host-service-data associated with the selected wireless-device-installed service further comprises an indication of an identity of the selected wireless-device-installed service.

7. The apparatus of claim 5 wherein the selected wireless-device-installed service comprises an email service.

8. The apparatus of claim 7 wherein the host-service-data disposition command commands deletion of host-service email and data comprising email attachments.

9. The apparatus of claim 1 wherein said data disposition command detector is configured to detect reception at the wireless device of a host-service-disposition command that commands deletion of host-service personal information manager information.

10. The apparatus of claim 9 wherein said data controller is configured to cause deletion of the host-service personal information manager information.

11. The apparatus of claim 1 wherein said data disposition command detector is configured to detect reception at the wireless device of a host-service-data-disposition command that commands blocking of transfer of host-service data to a non-enterprise-associated database.

12. The apparatus of claim 11 wherein said data controller is configured to cause blocking of the transfer of the host-service data to the non-host-service-associated database.

13. A method for facilitating host-service control of a wireless device, said method comprising:
detecting reception at the wireless device of a host-service-data disposition command; and
making disposition of host-service data at the wireless device responsive to the host-service-data disposition command detected during said detecting, the disposition of the host-service data preserving non-host-service-associated services provisioned at the personal-liable wireless device.

14. The method of claim 13 wherein said detecting comprises detecting reception at the wireless device of a host-service-data-disposition command that commands deletion of host-service data at the wireless device.

15. The method of claim 14 wherein the host-service-data disposition command detected during said detecting further comprises an indication of which portion of the host-service data that is commanded to be deleted.

16. The method of claim 13 wherein said detecting comprises detecting at the wireless device of a host-service-data-disposition command that commands deletion of the enterprise data associated with a selected wireless-device-installed service.

17. The method of claim 16 wherein the selected wireless-device-installed service comprises an email service.

18. The method of claim 13 wherein said detecting comprises detecting at the wireless device of a host-service-data-disposition command that commands deletion of host-service personal information manager information.

19. A network apparatus for facilitating wireless-device control, said apparatus comprising:
a selection detector configured to detect host-service selection to make disposition of wireless-device, host-service data; and
a command generator adapted to receive indication of selection detected by said selection detector, said command generator configured to generate a host-service-data disposition command that commands disposition of the wireless-device, host-service data in conformity with the selection while preserving non-host-service-associated services.

20. A method for facilitating wireless-device control by a host service provider, said method comprising:
detecting host-service selection to make disposition of wireless-device, host-service data; and
generating a host-service-data disposition command responsive to detection during said detecting of the host-service selection, the host-service-data disposition command commanding disposition of the wireless-device, host-service data in conformity with the selection while preserving wireless-device, non-host-service-associated services.

21. A method providing a service for controlling disposition of data stored at a wireless device, said method comprising:
generating a command; and
sending the command to the wireless device; and
operating upon the data in conformity with the command, wherein a portion of the data is deleted responsive to the command and wherein another portion of the data is unaffected by the command.

22. The method of claim 21 wherein the command generated during said generating is generated responsive to making disposition of the host-service data.

23. The method of claim 21 further comprising making disposition of host-service data.

24. The apparatus of claim 1 wherein the host-service-data disposition command detected by said data disposition command detector comprises a network-generated command.

25. The apparatus of claim 1 wherein the host-service-data disposition command comprises a generated command, generated responsive to making disposition of the host-service data.

26. The method of claim 13 wherein the host-service-data disposition command detected during said detecting comprises a network-generated command.

27. The method of claim 13 wherein the host-service-data disposition command comprises a generated command, generated responsive to making disposition of the host-service data.

28. The method of claim 20 wherein the host-service selection detected during said detecting comprises a network-generated command.

29. The method of claim 20 wherein said detecting comprises detection of a generated command, generated responsive to making disposition of host-service data.
